(19) United States
(12) Patent Application Publication
(10) Pub. No.: US 2017/0164102 A1
(43) Pub. Date: Jun. 8, 2017

(54) REDUCING MULTIPLE SOURCES OF SIDE INTERFERENCE WITH ADAPTIVE MICROPHONE ARRAYS

(71) Applicant: Motorola Mobility LLC, Chicago, IL (US)

(72) Inventor: Plamen A. Ivanov, Schaumburg, IL (US)

(21) Appl. No.: 14/962,045

(22) Filed: Dec. 8, 2015

(51) Int. Cl. H04R 1/40; H04R 3/00

(52) U.S. Cl. CPC H04R 1/406; H04R 3/005; H04R 2430/25; H04R 2201/405

(57) ABSTRACT

Configuring microphones in an array to gather signals from a desired source of sound in a main lobe, and configuring the microphones to gather side interference by controlling at least one of a relative phase or a relative magnitude of signals gathered by each of the microphones to provide a respective plurality of differential microphone arrays each having a corresponding directional pattern that orients a null towards the desired source of sound and that provides a side lobe. The gathered side interference from the plurality of differential microphone arrays is processed to generate a reference signal that is subtracted from the signals that are gathered from the main lobe to provide an output signal wherein the side interference is reduced or cancelled.

### FIELD OF THE DISCLOSURE

The present disclosure relates to audio processing and, more particularly, to methods and apparatuses for reducing multiple sources of side interference using adaptive microphone arrays.

### BACKGROUND OF THE DISCLOSURE

A microphone array is a group of two or more microphones arranged in a specific geometric configuration and used to gather and process acoustic signals. One advantage of using a microphone array over a single microphone lies in the fact that the array adds dimensional information to the signal acquisition process. Accordingly, beam forming techniques may be used to provide a main lobe for receiving signals of interest that arrive from one or more desired directions. Beam forming increases the gain of the microphone array in one or more desired directions, while decreasing the gain in other directions to thereby improve the signal-to-noise ratio of a desired signal.

Adaptive microphone arrays may be configured to reduce side interference from sources of acoustic energy that are not situated in the main lobe of the array. For example, a source of undesired noise may be situated outside of the main lobe of the array at a left side of the array, or at a right side of the array. Temporal and spatial information included in the signals collected by the microphone array are analyzed using array signal processing and adaptation procedures to formulate a filter transfer function for the array. The filter transfer function provides the microphone array with a fixed directional pattern that reduces the response of the array to side interference arriving from the left or the right of the array. A null, or direction of minimum response, is provided in a particular direction along a specific fixed bearing.

Side interference may be reduced by utilizing a first circuit that orients a null towards a desired signal source, as well as a second circuit that provides maximum sensitivity towards the main lobe including the desired signal source. The first circuit provides the null by generating a difference signal between a first pair of microphones in the array. This difference signal primarily includes signals gathered from the left side of the array in a first side lobe, and signals gathered from the right side of the array in a second side lobe, but little or no signals gathered from the main lobe of the array. The second circuit provides maximum sensitivity towards the main lobe by generating a summed signal or a differential signal from a second pair of microphones. For example, the summed signal primarily includes signals gathered from the main lobe of the array, along with some signals from the left and right sides of the array.

An adaptive filtering mechanism may be employed to perform an interference cancellation procedure. The first signal produced by the first circuit and containing little or no signal from the source is filtered and subtracted out of a second signal produced by the second circuit and including the source. A source located off-axis, such that it is located in the first or second side lobe, is removed from the sum signal by means of the adaptive filter. Thus, the adaptive filtering mechanism effectively provides the microphone array with a flexible directional pattern that reduces the response of the array to side interference. The adaptive array provides a flexible spatial response pattern so as to reduce sensitivity of the array to signal sources outside of the main lobe by tracking undesired interfering sources that are situated to the side of the array.

The foregoing approach may provide acceptable results where a single source of interference is to the right or to the left of the array, or where multiple sources of interference are all situated in the same direction (left or right) with respect to the array. However, this approach is less effective for cancelling side interference in situations where multiple sources of interference are located on both the right side and the left side of the array. Due to the fact that signals in the first side lobe of the array (and to the left of the array) are 180 degrees out of phase with respect to signals in the second side lobe of the array (and to the right of the array), when employing a conventional difference circuit, it is mathematically impossible for the adaptive filter to find a solution that will provide simultaneous cancellation of interference from both the right side and the left side of the array.

### BRIEF SUMMARY OF THE INVENTION

In at least some embodiments, the present invention relates to a method that includes configuring a plurality of microphones in an array to gather signals from a desired source of sound in a main lobe of the array, and configuring the plurality of microphones to gather side interference by controlling at least one of a relative phase or a relative magnitude of signals gathered by each of the plurality of microphones to provide a respective plurality of differential microphone arrays each having a corresponding directional pattern that orients a null towards the desired source of sound and that provides one or more side lobes. The gathered side interference from the plurality of differential microphone arrays is processed to generate a reference signal that is subtracted from the signals that are gathered from the main lobe of the array to provide an output signal wherein the side interference is reduced or cancelled.

According to a set of further embodiments, the reducing or cancelling of the side interference is provided by processing the reference signal through an adaptive filter which tracks one or more undesired signal sources. The reference signal is processed by means of adjusting and adapting a set of weights for the adaptive filter such that energy minimization in the final output is achieved. For illustrative purposes, the adaptive filter may be a finite impulse response (FIR) filter, and the adaptive filter may utilize an adaptive mechanism such as least mean squares (LMS).

In at least some embodiments, the present invention relates to an apparatus that includes a plurality of microphones arranged in an array for gathering signals from a desired source of sound in a main lobe of the array. A phasing or filtering mechanism, operatively coupled to the plurality of microphones, configures the array for gathering side interference by controlling at least one of a relative phase or a relative magnitude of signals gathered by each of the plurality of microphones to provide a respective plurality of differential microphone arrays each having a corresponding directional pattern that orients a null towards the desired source of sound and that provides one or more side lobes. A processing mechanism, operatively coupled to the phasing or filtering mechanism and the array, processes the gathered side interference from the plurality of differential microphone arrays to generate a reference signal that is subtracted from the signals that are gathered from the main lobe of the array to provide an output signal wherein the side interference is reduced or cancelled.

Moreover, in at least some embodiments, the present invention relates to a non-transitory computer-readable memory encoded with a computer program comprising computer readable instructions recorded thereon for execution of a method that includes configuring a plurality of microphones in an array to gather signals from a desired source of sound in a main lobe of the array, and configuring the plurality of microphones to gather side interference by controlling at least one of a relative phase or a relative magnitude of signals gathered by each of the plurality of microphones to provide a respective plurality of differential microphone arrays each having a corresponding directional pattern that orients a null towards the desired source of sound and that provides one or more side lobes. The gathered side interference from the plurality of differential microphone arrays is processed to generate a reference signal that is subtracted from the signals that are gathered from the main lobe of the array to provide an output signal wherein the side interference is reduced or cancelled.

### BRIEF DESCRIPTION OF THE DRAWINGS

FIG. 1 is a hardware block diagram of an illustrative prior art adaptive microphone array for cancelling side interference.

FIG. 2 is a hardware block diagram of a prior art differential microphone array.

FIG. 3 is a hardware block diagram of another prior art differential microphone array.

FIG. 4 is a hardware block diagram of yet another prior art microphone array.

FIG. 5 is a hardware block diagram of a first illustrative adaptive microphone array constructed in accordance with a set of exemplary embodiments.

FIG. 6 illustrates a plurality of exemplary directional patterns provided by the configuration of FIG. 5 according to a set of exemplary embodiments.

FIG. 7 is a flowchart showing an illustrative operational sequence for reducing multiple sources of acoustical side interference in accordance with a set of exemplary embodiments.

FIG. 8 is a hardware block diagram showing an illustrative mobile device for reducing multiple sources of acoustical side interference in accordance with a set of exemplary embodiments.

FIG. 9 is a hardware block diagram of a second illustrative adaptive microphone array constructed in accordance with a set of exemplary embodiments.

FIG. 10 is a hardware block diagram of a third illustrative adaptive microphone array constructed in accordance with a set of exemplary embodiments.

### DETAILED DESCRIPTION

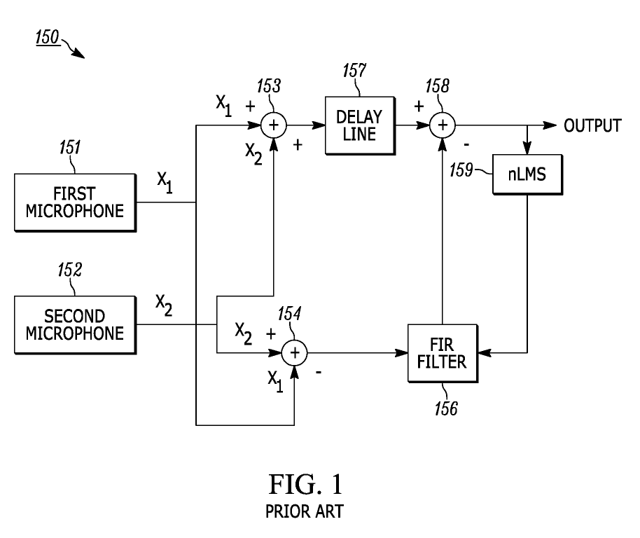

FIG. 1 is a hardware block diagram of an illustrative prior art real-time adaptive microphone array 150 for cancelling side interference. A first output signal from a first microphone 151 is applied to a first non-inverting input of a first summer 153. A second output signal from a second microphone 152 is applied to a second non-inverting input of the first summer 153. The first summer 153 generates a sum of the first and second output signals to provide a spatially defined directional pattern having a maximum sensitivity in a direction perpendicular to a line that connects or joins the first and second microphones 151 and 152. This direction of maximum sensitivity may be regarded as an intended look-up direction of the array. The sum provided by the first summer 153 is fed to an input of a delay line 157. An output of the delay line 157 is applied to a non-inverting input of a third summer 158.

A second summer 154 is used to invert either the first output signal from the first microphone 151 or the second output signal from the second microphone 152 prior to summing the first and second output signals, to generate a difference signal between the first microphone 151 and the second microphone 152. The difference signal provides a minimum sensitivity along the look-up direction of the array, and provides a maximum sensitivity in a direction defined by the line connecting the two microphones. Thus the maximum sensitivity direction of the summation branch at the output of the first summer 153 coincides with the minimum sensitivity of the difference branch at the output of the second summer 154 of the array 150. The output of the difference branch at the output of the second summer 154 is then filtered by a finite impulse response (FIR) filter 156, which is trained using an adaptive algorithm such as normalized least mean squares (nLMS) 159, for example, to remove a maximum common signal that is present in both the sum and difference branches by means of a third summer 158. This maximum common signal is located to the sides of the look-up direction of the array 150. The nLMS algorithm represents a class of adaptive filter used to mimic a desired filter by determining a set of filter coefficients that produce a least mean square of an error signal. The error signal represents the difference between a desired signal and an actual signal. The nLMS algorithm constitutes a stochastic gradient descent method in that the filter is adapted based on the error at the current moment in time.

The arrays described in conjunction with FIG. 1 may provide acceptable results as long as speech leakage is minimal (or ideally non-existent) in the output of the second summer 154. In at least some embodiments or circumstances, speech leakage may be reduced or eliminated by implementing the sum and difference arrays using a larger number of microphones. Moreover, the look-up direction of the array can be steered by adding appropriate delays on one (or more of) the microphone signals. But there are practical limits to the maximum number of microphones that can be used, and there are also limitations with regard to a delay and sum beam former (DSB) approach. Reducing leakage to a tolerable level may prove difficult or impossible to achieve.

The use of a DSB in the array 150 of FIG. 1 presents challenges in the way that a directional spatial response pattern is formed. The directivity does not remain constant across a broad range of audible frequencies, but rather, the directivity is a function of frequency. Also, in the general case of a broad-side array such as the DSB, the directivity is symmetrical, exhibiting a maximum sensitivity on both sides of a line connecting or joining the two (or more) microphones 151, 152.

Another approach is to use a differential microphone array (DMA) that forms a signal oriented along an intended look-up direction comprising a main lobe of the array. In a DMA, a first signal from a first microphone is delayed with respect to a second signal from a second microphone, and then the first signal is subtracted from the second signal. The amount of delay introduced into the first signal and the geometry of the array determine the direction of the null(s) formed by the array. DMAs are of relatively constant directivity, at least up to a specific frequency and dependent on the geometry of the array. DMAs allow minimum sensitivity (a null) to be directed at two arbitrary angles, axially symmetric to the line connecting the two or more microphones. The differential array is an end-fire array, and the maximum sensitivity of the array is along the line connecting the two or more microphones.

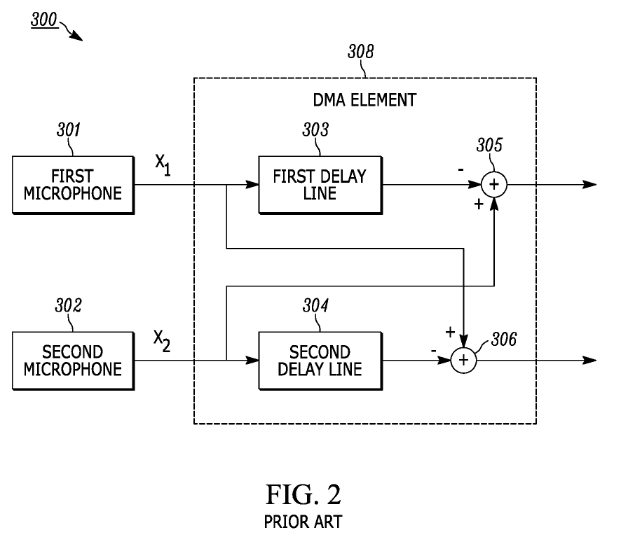

FIG. 2 is a hardware block diagram of a prior art differential microphone array 300. A first signal from a first microphone 301 is applied to a first delay line 303 that provides a first delay. A second signal from a second microphone 302 is applied to a second delay line 304 that provides a second delay. For illustrative purposes, the first delay could be of a time duration that is identical to the second delay, or alternatively, the second delay may be of a time duration that is different from the first delay. Also, for example, in some embodiments either of the first delay line 303 or the second delay line 304 can provide a frequency dependent delay.

The first signal from the first microphone 301 is delayed with respect to the second signal from the second microphone 302 by means of the first delay line 303, and the delayed first signal is subtracted from the second signal using a first summer 305. Likewise, the second signal from the second microphone 302 is delayed with respect to the first signal from the first microphone 301 by means of the second delay line 304, and the delayed second signal is subtracted from the first signal using a second summer 306.

The amount of delay introduced by the first and second delay lines 303, 304 and the geometry of the array 300 determine the direction of the null(s) formed by the array 300. For example, the first summer 305 may provide an output signal that illustratively implements a cardioid-shaped spatial response pattern, with the null of the cardioid directed to the left of the array 300, and with the main lobe of the cardioid directed to the right of the array 300. The second summer 306 may provide an output signal that illustratively implements a cardioid-shaped spatial response pattern, with the null of the cardioid directed to the right of the array 300, and with the main lobe of the cardioid directed to the left of the array 300. The first delay line 303, the second delay line 304, the first summer 305, and the second summer 306 together comprise a differential microphone array (DMA) element 308.

The delay introduced by the first and second delay lines 303, 304 may, but need not, be a function of frequency. It should be appreciated that any one or more of the delay lines 303, 304 (or otherwise) can take any of a variety of forms depending upon the embodiment or circumstance and, for example, can be an integer sample delay, a fractional sample delay, a frequency dependent delay, or a delay filter. Also, implementations may be provided in the time domain or the frequency domain. The array 300 conceptually illustrates how a set of processing elements (delay lines 303, 304 and summers 305, 306) may be used to produce signals with opposing spatial directivities, such as the right-oriented cardioid and left-oriented cardioid discussed previously.

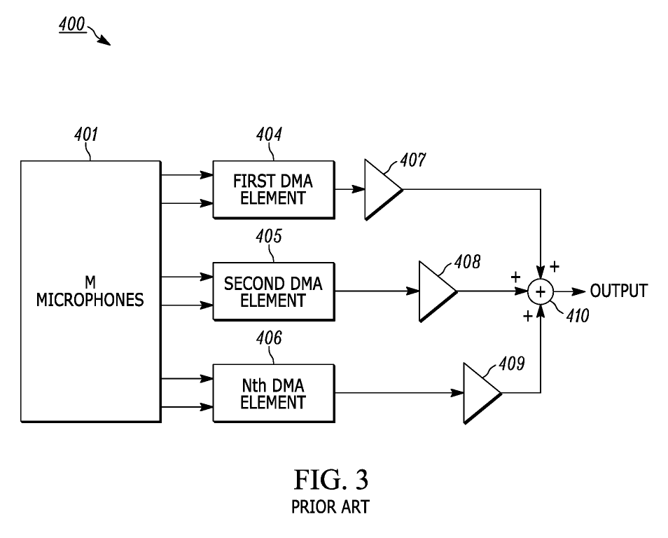

FIG. 3 is a hardware block diagram of another prior art differential microphone array 400. Provided that certain conditions are met (such as geometrical distribution of physical microphones, and relative delays introduced to form DMAs), multiple DMAs can be linearly combined to provide spatial directional patterns of arbitrary shape and orientation. The array 400 of FIG. 3 illustrates this concept. The outputs of multiple differential arrays are weighted (in the general case this may include a filter) to produce a final pattern of desired directivity and shape.

The array 400 of FIG. 3 includes a plurality M of microphones 401, where M is a positive integer greater than one. Each of respective microphones of the plurality M of microphones 401 generates a corresponding microphone output signal. For explanatory purposes, assume that the plurality M of microphones 401 includes at least a first, a second, a third, and a fourth microphone. A first microphone output signal from the first microphone is fed to a first input of a first differential microphone array (DMA) element 404, and a second microphone output signal from the second microphone is fed to a second input of the first DMA element 404. Likewise, a third microphone output signal from the third microphone is fed to a first input of a second DMA element 405, and a fourth microphone output signal from the fourth microphone is fed to a second input of the second DMA element 405. For purposes of illustration, the first microphone output signal is fed to a first input of an Nth DMA element 406, and the fourth microphone output signal is fed to a second input of the Nth DMA element 406. Each of the first, second, and third DMA elements 404, 405 and 406 may be identical or similar to the DMA element 308 of FIG. 2.

An output of the first DMA element 404 is fed to an input of a first amplifier 407, an output of the second DMA element 405 is fed to an input of a second amplifier 408, and an output of the Nth DMA element 406 is fed to an input of an Nth amplifier 409. Each amplifier may provide frequency dependent amplification. An output of the first amplifier 407 is fed to a first non-inverting input of a summer 410. An output of the second amplifier 408 is fed to a second non-inverting input of the summer 410. An output of the Nth amplifier 409 is fed to an Nth non-inverting input of the summer 410. An output from the summer 410 is regarded as the output of the array 400. The characteristics of the first, second, and Nth DMA elements 404, 405 and 406 may each be adjusted, along with the gains provided by each of the first, second, and third amplifiers 407, 408, and 409 to provide any of a plurality of spatial directivity patterns. Provided that certain conditions are met, including an adequate spatial distribution of physical microphones, any number of microphones 401, 402, 403, DMA elements 404, 405, 406, and amplifiers 407, 408, 409 can be linearly combined by the summer 410, to form spatial directivity patterns of arbitrary shapes and orientations.

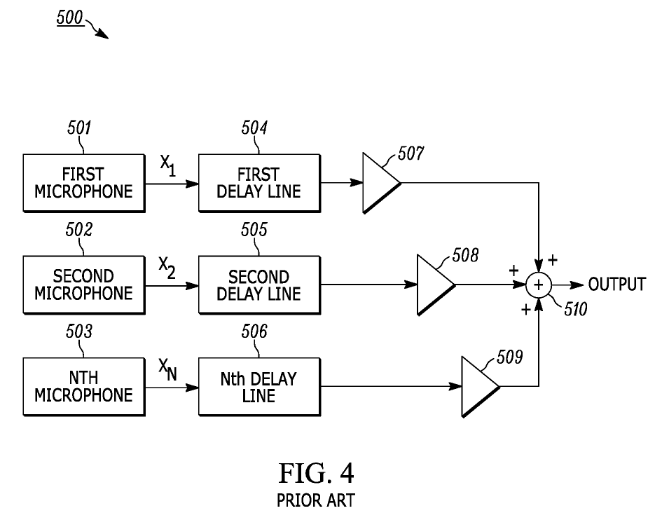

FIG. 4 is a hardware block diagram of a prior art delay and sum beam former (DSB) microphone array 500. The array 500 includes a respective plurality of microphones, such as a first microphone 501, a second microphone 502, and an Nth microphone 503, that are configured for providing a corresponding plurality of output signals X₁, X₂, and X_{N} in real time. The output signal X₁ from the first microphone 501 is fed to an input of a first delay line 504. Likewise, the output signal X₂ from the second microphone 502 is fed to an input of a second delay line 505. Similarly, the output signal X_{N} from the Nth microphone 503 is fed to an input of an Nth delay line 506. An output of the first delay line 504 is fed to an input of a first amplifier 507, an output of the second delay line 505 is fed to an input of a second amplifier 508, and an output of the Nth delay line 506 is fed to an input of an Nth amplifier 509.

An output of the first amplifier 507 is fed to a first non-inverting input of a summer 510. An output of the second amplifier 508 is fed to a second non-inverting input of the summer 510. An output of the Nth amplifier 509 is fed to an Nth non-inverting input of the summer 510. An output from the summer 510 is regarded as the output of the array 500. The delays provided by the first, second, and Nth delay lines 504, 505, and 506 may each be adjusted, along with the gains provided by each of the first, second, and third amplifiers 507, 508, and 509 to provide any of a plurality of spatial directivity patterns. Provided that certain conditions are met, including an at least minimal spatial distribution of physical microphones, any number of microphones 501, 502, 503, delay lines 504, 505, 506, and amplifiers 507, 508, 509 can be linearly combined by the summer 510, to form spatial directivity patterns of arbitrary shapes and orientations.

According to a set of illustrative embodiments disclosed herein, methods are provided for reducing multiple sources of side interference using adaptive microphone arrays. For illustrative purposes, the adaptive microphone array may, but need not, be implemented using any of the systems described previously in connection with FIGS. 1-4. A plurality of microphones in an array gathers signals from a desired source of sound in a main lobe of the array. The plurality of microphones also gathers side interference such that at least one of a relative phasing or a filtering for each of the plurality of microphones is controlled to provide a respective plurality of differential microphone arrays each having a corresponding directional pattern that orients a null towards the desired source of sound and that provides one or more side lobes. The gathered side interference from the plurality of differential microphone arrays is processed to generate a reference signal that is subtracted from the signals that are gathered from the main lobe of the array to provide an output signal wherein the side interference is reduced or cancelled.

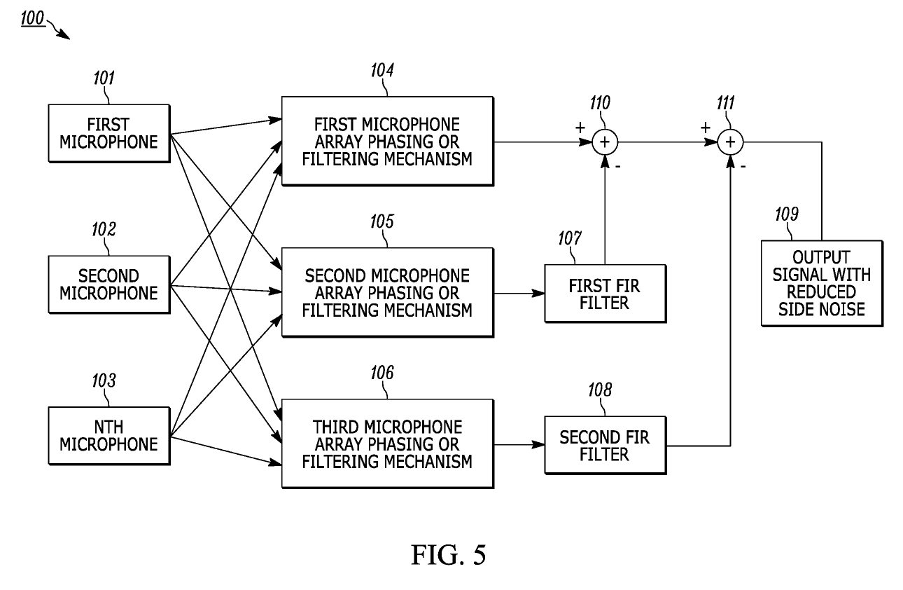

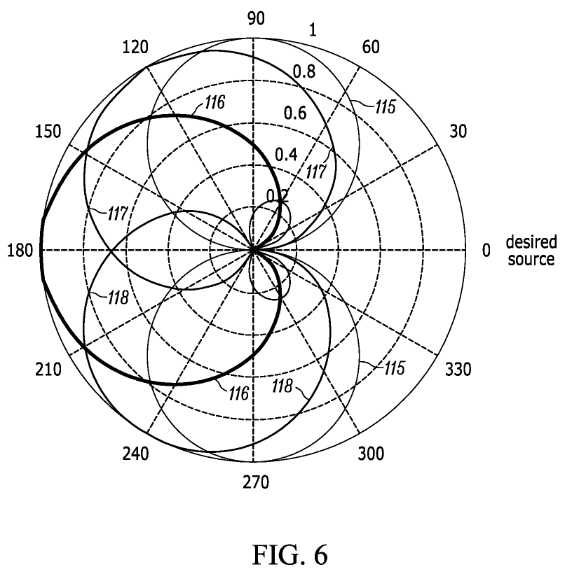

FIG. 5 is a hardware block diagram of an illustrative adaptive microphone array 100 for providing multiple-side interference cancellation in accordance with a set of exemplary embodiments. FIG. 5 will be discussed in conjunction with FIG. 6, which illustrates a plurality of exemplary directional patterns provided by the configuration of FIG. 5 according to a set of exemplary embodiments.

Refer now to FIG. 5. The array 100 is configured for gathering signals from one or more signal sources in a main lobe of the array 100, and is also configured for reducing side interference gathered from one or more noise sources that are not situated within the main lobe of the array 100. The array 100 includes a respective plurality of microphones, such as a first microphone 101, a second microphone 102, and an N^{th} microphone 103, that are configured for gathering a corresponding plurality of signals X₁, X₂, and X₃ in real time.

The first, second, and Nth microphones 101, 102, and 103 gather signals from a desired source of sound in a main lobe of the array 100. The main lobe of the array 100 may be defined as the look-up direction of the array 100. In the example of FIG. 5, for the Nth microphone 103, N represents a positive integer greater than one. However, three microphones are shown for purposes of illustration, as the array 100 may include any number of two or more microphones. A first microphone array phasing or filtering mechanism 104 controls a relative phasing or filtering of the first, second, and Nth microphones 101, 102, 103 to provide a maximum amplitude response in a main lobe of the array for receiving acoustic signals from a desired source. Receiving acoustic signals from the desired source can be accomplished by using a delay and sum beam forming (DSB) array, a differential array, or even using a signal from a single microphone. Note that time domain processing, or frequency domain processing, or both time domain processing and frequency domain processing, can be used to modify phase and magnitude.

The first, second, and Nth microphones 101, 102, and 103 are also used to gathers side interference from one or more sources of undesired noise that are situated outside of the main lobe of the array. A relative phasing or filtering for each of the first, second, and Nth microphones 101, 102, and 103 is controlled to provide a respective plurality of differential microphone arrays each having a corresponding directional pattern that orients a null towards the desired source of sound and that provides one or more side lobes. For example, a second microphone array phasing or filtering mechanism 105 controls a relative phase and/or magnitude of the first, second, and Nth microphones 101, 102, and 103 to provide a first directional pattern 115 (FIG. 6) that includes one or more side lobes for gathering side interference. In the illustrative example of FIG. 6, the first directional pattern 115 is a dipole-shaped pattern with nulls directed towards 0 degrees and 180 degrees, but any other directional pattern that provides side lobes may be used so long as the directional pattern has a spatial characteristic of a cardioid, a dipole, or any shape that is between a cardioid and a dipole. For example, a directional pattern in the form of an arbitrary limacon may be provided.

A third microphone array phasing or filtering mechanism 106 (FIG. 5) controls the relative phase and/or magnitude of the first, second, and Nth microphones 101, 102, and 103 to provide a second directional pattern 116 (FIG. 6) that also includes one or more side lobes for gathering side interference. In the illustrative example of FIG. 6, the second directional pattern 116 is a cardioid-shaped pattern with a main lobe directed towards 180 degrees. The generation of the first and second directional patterns 115 and 116 (FIG. 6) may be provided, for example, using any of the illustrative configurations shown in FIGS. 1-5. For example, a microphone mixer may be used to maximize an output signal in a specific spatial orientation so as to provide arbitrary directivity and spatial orientation by mixing together a plurality of directional signals. In general, the directional patterns of FIG. 6 may be conceptualized as including a plurality of limacons, each of the respective plurality of limacons being oriented to provide a corresponding null that point to where a desired signal source is expected to be situated, and each of the plurality of limacons serving as reference for one or multiple side interference sources to be removed.

FIG. 6 illustrates the directivity provided by a set of microphones, such as the first second, and Nth microphones 101, 102, and 103 of FIG. 5, to provide improved cancellation of multiple side-located interference sources. Improved cancellation is provided by steering the nulls of multiple directional received signals gathered by the microphones 101, 102, and 103 towards a desired talker, while their respective look-up directions cover a perimeter where potential interference can be located, and to use these signals as references to train a multiple loop adaptive system. These reference signals are then processed and extracted from a signal oriented in the direction of the desired source. An arbitrary set of DMAs are formed using signals gathered by the microphones 101, 102, and 103, such that their nulls are steered in the direction of the desired talker or signal source.

In FIG. 6, the desired talker or signal source is assumed to be located at 0 degrees. These DMAs are then used to provide signals in which the side interference sources are dominating, and the desired source is minimized (being located in the null of the array, where maximum attenuation is achieved). In the embodiment of FIG. 6, a total of five arrays are formed to be used as side-reference signals: the first directional pattern 115 comprising two dipoles of opposed polarity with nulls oriented at 0 and 180 degrees, the second directional pattern 116 comprising the cardioid with a null oriented at 0 degrees, a third directional pattern 117 comprising a super-cardioid with a main lobe oriented at 120 degrees, and a fourth directional pattern 118 comprising a super-cardioid with a main lobe oriented at 240 degrees.

The first, second, third, and fourth directional patterns 115, 116, 117, and 118 all have nulls that are oriented at 0 degrees. Note that the location of this null can be “fixed” by design. The null can be oriented in a direction, where it is a priory known the desired talker will be located (for example, on the display side of a mobile device, or in front of a TV set. or appliance). Alternatively, the direction in which the desired talker is located can be tracked by either external means (for example, using camera(s) or other sensors on the device to detect when a person moves out of the “null” region), or by other methods such as tracking the voice of a known talker and the direction of arrival or location of that talker with respect to the microphone array 100 (FIG. 5) itself. In the case of tracking, the null (and the entire pattern illustrated in FIG. 6) is then re-oriented in a specific direction, by for example combining a set of directional signals, to form a new set of signals in that orientation, using a circuit/method as illustrated in any of FIGS. 1-5.

The array 100 of FIG. 5 shows three microphone array phasing or filtering mechanisms 104, 105, and 106 for illustrative purposes. In some embodiments, the three microphone array phasing or filtering mechanisms 104, 105, and 106 may be implemented using a single set of phasing or filtering elements that are switched among the various microphones in the array using a single processing mechanism. Furthermore, it should be understood that any number of microphone array phasing or filtering mechanisms may be utilized, so long as at least one microphone array phasing or filtering mechanism provides a main lobe towards a desired source and at least two additional microphone array phasing or filtering mechanisms provide side lobes towards one or more sides of the array 100. Optionally, a single component could, but need not, be used to produce a plurality of signals for driving the array 100.

Any number of different directional patterns may be provided by means of microphone array phasing or filtering mechanisms including the first, second, and third microphone array phasing or filtering mechanisms 104, 105, and 106 and optional additional microphone array phasing or filtering mechanisms. FIG. 6 shows a third directional pattern 117 and a fourth directional pattern 118 which are both illustrative examples of directional patterns that have spatial characteristics of a cardioid, a dipole, any shape that is between a cardioid and a dipole, or any of a variety of arbitrarily-shaped limacons. For illustrative purposes, the second directional pattern 116 comprises a first side lobe oriented for gathering side interference from a right side of the array or above the array, and a second side lobe oriented for gathering side interference from a left side of the array or below the array.

The gathered side interference from the second and third microphone array phasing or filtering mechanisms 105 and 106 is processed to generate a reference signal that is subtracted from the signals that are gathered from the main lobe of the array by the first microphone array phasing or filtering mechanism 104 to provide an output signal wherein the side interference is reduced or cancelled 109. In the example of FIG. 5, the gathered side interference is processed using a first FIR filter 107 operatively coupled to the second microphone array phasing or filtering mechanism 105, and a second FIR filter 108 operatively coupled to the third microphone array phasing or filtering mechanism 106.

The first FIR filter 107 generates a first reference signal, which contains the undesired interference source that is subtracted from the output of the first microphone array phasing or filtering mechanism using an inverting input of a first summer 110, and the second FIR filter 108 generates a second reference signal that is subtracted from the output of the first summer using an inverting input of a second summer 111. The output of the second summer 111 represents an output signal with reduced side noise 109. By way of example, the first and second reference signals generated by the first and second FIR filters 107 and 108 may illustratively be used as inputs for a noise estimation procedure to be performed by a noise suppressor.

The first FIR filter 107 and the second FIR filter 108 may each include a delay line that is implemented using a set of memory elements. The first and second FIR filters 107 and 108 are shown for illustrative purposes, as more than two FIR filters may be provided. The first and second FIR filters 107 and 108 each exhibit an “impulse response” in the form of a set of FIR coefficients or weights. For example, if an impulse, such as a single “1” sample followed by many “0” samples, is fed to the input of the first FIR filter 107, the output of the filter will be a set of coefficients or weights where the “1” sample sequentially moves past each coefficient in turn to form the output of the first FIR filter 107. In the example of FIG. 5, the first and second FIR filters 107 and 108 are shown for illustrative purposes, as a single FIR filter element may be used to implement both the first and second FIR filters 107, 108.

Illustratively, the first FIR filter 107 and second FIR filter 108 could, but need not, be implemented using a digital signal processor (DSP) microprocessor that is configured for executing one or more looped instructions. The first and second FIR filters 107 and 108 may be configured for performing multi-rate applications such as decimation (reducing the sampling rate), interpolation (increasing the sampling rate), or both. One or more taps may be provided by the first and second FIR filters 107 and 108 where each tap represents a coefficient/delay pair. The number of FIR taps may be selected in accordance with a desired amount of filtering to be performed by the first FIR 107 or the second FIR filter 108. Typically, the first and second FIR filters 107 and 108 do not provide a clearly defined stop-band/pass-band. Rather, the weights of the filter and the resulting filter shape approximate a transfer function describing a spatio-temporal relationship between an interference source and a set of microphones forming the two signals (desired and reference). Thus, increasing the taps of the first and/or second FIR filters 107 and 108 leads to better tracking of, and consequently removal of the unwanted source.

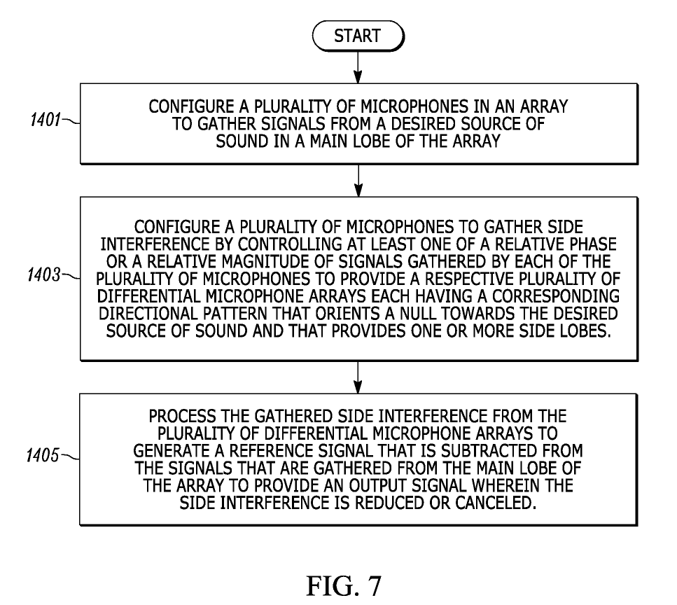

FIG. 7 is a flowchart showing an illustrative operational sequence for reducing multiple sources of acoustical side interference in accordance with a set of exemplary embodiments. The operational sequence commences at block 1401 where a plurality of microphones in an array are configured to gather signals from a desired source of sound in a main lobe of the array. The operational sequence progresses to block 1403 where the plurality of microphones are configured to gather side interference by controlling a relative phase and/or magnitude for each of the plurality of microphones to provide a respective plurality of differential microphone arrays each having a corresponding directional pattern that orients a null towards the desired source of sound and that provides one or more side lobes. Next, at block 1405, the gathered side interference from the plurality of differential microphone arrays is processed to generate a reference signal that is subtracted from the signals that are gathered from the main lobe of the array to provide an output signal wherein the side interference is reduced or cancelled.

The aforementioned operational sequence of FIG. 7 is merely an example that is intended to be encompassed by the present disclosure. The present disclosure is intended to encompass numerous other manners of operation in addition to those specifically described previously. Numerous other examples of operation in accordance with the processes of FIG. 7, or variations of these processes, can be envisioned and are encompassed herein.

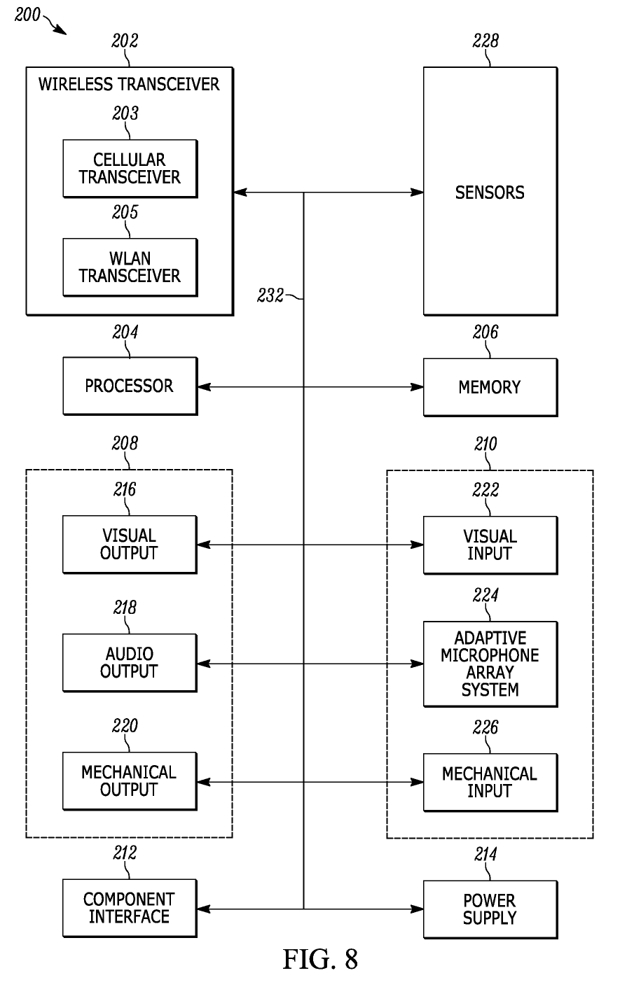

FIG. 8 is a hardware block diagram showing an illustrative mobile device for reducing multiple sources of acoustical side interference in accordance with a set of exemplary embodiments. The mobile device 200 is representative of any communication device that is operated by persons (or users) or possibly by other entities (e.g., other computers) desiring or requiring communication capabilities. In some embodiments, for example, the mobile device 200 may be any of a smartphone, a cellular telephone, a personal digital assistants (PDA), another type of handheld or portable electronic device, a headset, an MP3 player, a battery-powered device, a wearable device, a wristwatch, a radio, a navigation device, a laptop or notebook computer, a netbook, a pager, a PMP (personal media player), a DVR (digital video recorder), a gaming device, a game interface, a camera, an e-reader, an e-book, a tablet device, a navigation device with a video-capable screen, a multimedia docking stations, or another type of electronic mobile device.

As shown in FIG. 8, an illustrative mobile device 200 includes one or more wireless transceivers 202, a processor 204 (e.g., a microprocessor, microcomputer, application-specific integrated circuit, etc.), a memory 206, one or more output devices 208, and one or more input devices 210. In at least some embodiments, a user interface is present that comprises one or more output devices 208, such as a display, and one or more input devices 210, such as a keypad or touch sensor. The mobile device 200 can further include a component interface 212 to provide a direct connection to auxiliary components or accessories for additional or enhanced functionality. The mobile device 200 preferably also includes a power supply 214, such as a battery, for providing power to the other internal components while enabling the mobile device to be portable. Some or all of the components of the mobile device 200 can be coupled to one another, and in communication with one another, by way of one or more internal communication links 232 (e.g., an internal bus).

In the present embodiment of FIG. 8, the wireless transceivers 202 particularly include a cellular transceiver 203 and a wireless local area network (WLAN) transceiver 205. More particularly, the cellular transceiver 203 is configured to conduct cellular communications, such as 3G, 4G, 4G-LTE, etc., vis-à-vis cell towers (not shown), albeit in other embodiments, the cellular transceiver 203 can be configured instead or additionally to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof

The WLAN transceiver 205 may, but need not, be configured to conduct Wi-Fi communications in accordance with the IEEE 802.11 (a, b, g, or n) standard with access points. In other embodiments, the WLAN transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the WLAN transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, although in the present embodiment the mobile device 108 has two of the wireless transceivers 203 and 205, the present disclosure is intended to encompass numerous embodiments in which any arbitrary number of (e.g., more than two) wireless transceivers employing any arbitrary number of (e.g., two or more) communication technologies are present.

Exemplary operation of the wireless transceivers 202 in conjunction with others of the internal components of the mobile device 200 can take a variety of forms and can include, for example, operation in which, upon reception of wireless signals, the internal components detect communication signals and one or more of the wireless transceivers 202 demodulate the communication signals to recover incoming information, such as voice and/or data, transmitted by the wireless signals. After receiving the incoming information from one or more of the wireless transceivers 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceivers 202 convey the modulated signals by way of wireless and (possibly wired as well) communication links to other devices such as a server and possibly one or more content provider websites (as well as possibly to other devices such as a cell tower, access point, or another server or any of a variety of remote devices).

Depending upon the embodiment, the mobile device 200 may be equipped with one or more input devices 210, or one or more output devices 208, or any of various combinations of input devices 210 and output devices 208. The input and output devices 208, 210 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 can include, among other things, a video screen.

The input devices 210 (FIG. 8) include one or more audio input devices such as an adaptive microphone array system 224. The adaptive microphone array system 224 includes the real-time adaptive microphone array 100 of FIG. 5. Likewise, by example, the input devices 210 (FIG. 8) may, but need not, include one or more sensors 228, or one or more mechanical input devices 226 such as a flip sensor, keyboard, keypad, selection button, navigation cluster, touch pad, touchscreen, capacitive sensor, motion sensor, or switch. Actions that can actuate one or more of the input devices 210 can include not only the physical pressing/actuation of buttons or other actuators, but can also include, for example, opening the mobile device (if it can take on open or closed positions), unlocking the device, moving the device to actuate a motion, moving the device to actuate a location positioning system, and operating the device.

The mobile device 200 may also include one or more of various types of sensors 228. The sensors 228 can include, for example, proximity sensors (a light detecting sensor, an ultrasound transceiver or an infrared transceiver), touch sensors, altitude sensors, a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 200. Although the sensors 228 are for the purposes of FIG. 8 considered to be distinct from the input devices 210, in other embodiments it is possible that one or more of the input devices can also be considered to constitute one or more of the sensors (and vice-versa). Additionally, even though in the present embodiment the input devices 210 are shown to be distinct from the output devices 208, it should be recognized that in some embodiments one or more devices serve both as input device(s) and output device(s). For example, in embodiments where a touchscreen is employed, the touchscreen can be considered to constitute both a visual output device and a mechanical input device.

The memory 206 of the mobile device 200 can encompass one or more memory devices of any of a variety of forms (e.g., read-only memory, random access memory, static random access memory, dynamic random access memory, etc.), and can be used by the processor 204 to store and retrieve data. The memory 206 may comprise a computer-readable memory. In some embodiments, the memory 206 can be integrated with the processor 204 in a single device (e.g., a processing device including memory or processor-in-memory (PIM)), albeit such a single device will still typically have distinct portions/sections that perform the different processing and memory functions and that can be considered separate devices.

The data that is stored by the memory 206 can include, but need not be limited to, operating systems, applications, and informational data, such as a database. Each operating system includes executable code that controls basic functions of the communication device, such as interaction among the various components included among the mobile device 200, communication with external devices via the wireless transceivers 202 and/or the component interface 212, and storage and retrieval of applications and data, to and from the memory 206. In addition, the memory 206 can include one or more applications for execution by the processor 204. Each application can include executable code that utilizes an operating system to provide more specific functionality for the communication devices, such as file system service and the handling of protected and unprotected data stored in the memory 206.

Informational data is non-executable code or information that can be referenced and/or manipulated by an operating system or application for performing functions of the communication device. One such application is a client application which is stored in the memory 206 and configured for performing the methods described herein. The client application is intended to be representative of any of a variety of client applications that can perform the same or similar functions on any of various types of mobile devices, such as mobile phones, tablets, laptops, etc. The client application is a software-based application that operates on the processor 204 and is configured to provide an interface between one or more input devices 210, or one or more output devices 208, or any of various combinations thereof. In addition, the client application governs operation of one or more of the input and output devices 210, 208. Further, the client application may be configured to work in conjunction with a visual interface, such as a display screen, that allows a user of the mobile device 200 to initiate various actions. The client application can take any of numerous forms and, depending on the embodiment, be configured to operate on, and communicate with, various operating systems and devices. It is to be understood that various processes described herein as performed by the mobile device 200 can be performed in accordance with operation of the client application in particular, and/or other application(s), depending on the embodiment.

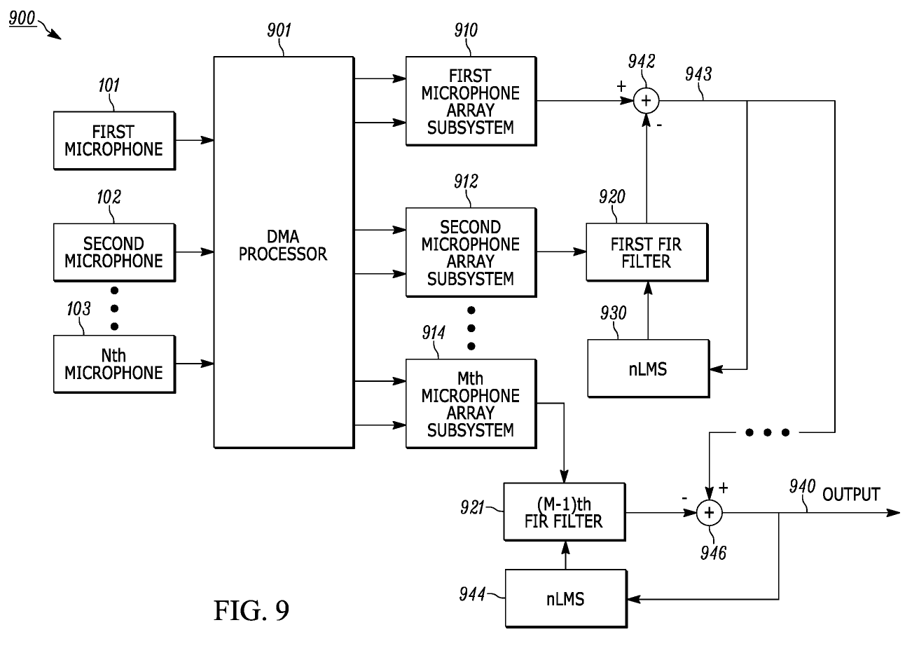

FIG. 9 is a hardware block diagram of a second illustrative adaptive microphone array 900 for providing multiple-side interference cancellation in accordance with a set of exemplary embodiments. A plurality of microphones are provided, including a first microphone 101, a second microphone 102, and one or more additional microphones up to an Nth microphone 103. As represented by dots provided between the second microphone 102 and the Nth microphone 103, the diagram is intended to indicate that any number N of three or more microphones can be present. At the same time, it should also be understood that at least three microphones are needed in order to produce all of the various patterns illustrated in FIG. 6.

Further as shown, signals gathered by each of the first microphone 101, the second microphone 102, and the one or more additional microphones represented by the Nth microphone 103 are applied to a differential microphone array (DMA) processor 901. The DMA processor 901 uses differential processing to generate a plurality of differential output signals from the first microphone 101, second microphone 102, and one or more additional microphones represented by the Nth microphone 103. In turn, a first differential output signal is applied by the DMA processor 901 to a first microphone array subsystem 910, a second differential output signal is applied by the DMA processor to a second microphone array subsystem 912, and one or more additional differential output signals are respectively applied to one or more additional microphone array subsystems that are represented by an Mth microphone array subsystem 914. Again, as represented by dots provided between the second microphone array subsystem 912 and the Mth microphone array subsystem 914, the diagram is intended to indicate that any number M of three or more microphone array subsystems can be present. In the example of FIG. 9, M would be set to equal five if the directional patterns shown in FIG. 6 are to be provided. Depending upon the embodiment, M can represent a positive integer greater than one (notwithstanding the above discussion showing M as being a positive integer greater than two).

Each of the microphone array subsystems 910, 912, and 914 produces a directional output signal that has a maximized amplitude response in a particular direction or set of directions, so as to provide spatial directivity. In the present example, the directivity of the first microphone array subsystem 910 is arranged such that it is most sensitive in a direction corresponding to that of a desired talker or acoustic source (corresponding to 0 degree on FIG. 6). The second and Mth microphone array subsystems 912 and 914 are oriented such that their respective nulls or regions of minimum sensitivity falls in the direction of 0, towards a desired source such as a talker, while their maximum sensitivity falls in directions or bearings of 90 degrees through 270 degrees with reference to FIG. 6. With this embodiment, any number of different shapes and orientations are possible.

Illustratively, one or more of the microphone array subsystems additionally are operatively coupled to one or more corresponding FIR filters that are equipped to perform nLMS procedures and to generate an output signal 940. More particularly, in the present embodiment, the second microphone array subsystem 912 is coupled to a first FIR filter 920, which receives both an output signal from the second microphone array subsystem 912 and also a nLMS signal from a first nLMS procedure block 930. An output signal from the first FIR filter 920 in turn is subtracted from an output signal provided from the first microphone array subsystem 910, at a first summing junction 942, to output a first difference signal 943.

Additionally it should be appreciated from FIG. 9 that each additional one or more of the microphone array subsystems represented by the Mth microphone array subsystem 914 can operate in association with a corresponding FIR filter, nLMS procedure block, and summing junction. As noted above, in the present description it is the second microphone array subsystem 912 that intercommunicates with the first FIR filter 920, the first NLMS procedure block 930, and the first summing junction 942. Correspondingly, it should be appreciated that, in the case of any Mth microphone array, the corresponding FIR filter will be a (M−1)th FIR filter 921, that the corresponding nLMS procedure block 944 will be a (M−1)th nLMS procedure block, and that the corresponding summing junction will be a (M−1)th summing junction 946. Further, it should be appreciated (again, as represented by dots within the linkage shown between the summing junctions 942 and 946) that the output signal provided from the (M−1)th FIR filter 921 will be subtracted, at the (M−1)th summing junction 946, from a difference signal that is received from (M−2)th summing junction so as to generate a (M−1)th difference signal that is both provided to the (M−1)th nLMS procedure block and also provided to either a subsequent (e.g., Mth) summing junction or output as the output signal 940.

For example, in the event that the Mth microphone array subsystem 914 is a fourth microphone array subsystem (that is, in the case where M=4), the FIR filter 921 will be the third FIR filter, the NLMS procedure block 944 will be the third nLMS procedure block, and the summing junction 946 will be the third summing junction. In such case, the third summing junction would operate to subtract the output signal from the third FIR filter from the second difference signal output by a second summing junction (which is represented by, but not expressly shown in, FIG. 9) so as to generate a third difference signal that is both provided to the third nLMS procedure block (again, in this example, the block 944) and also output as the output signal 940.

Additionally in such an example embodiment, an (M−1)th microphone array subsystem would also be present and would be a third microphone array subsystem. That third microphone array subsystem would operate in conjunction with an (M−2)th FIR filter, an (M−2)th nLMS procedure block, and an (M−2)th summing junction that would respectively be a second FIR filter, a second nLMS procedure block, and a second summing junction, respectively. Further with respect to such an example embodiment, the second summing junction would operate to subtract the output signal from the second FIR filter from the first difference signal output by the first summing junction 942 so as to generate a second difference signal that would both be provided to the second nLMS procedure block and also be provided to the third summing junction constituting the (M−1)th summing junction.

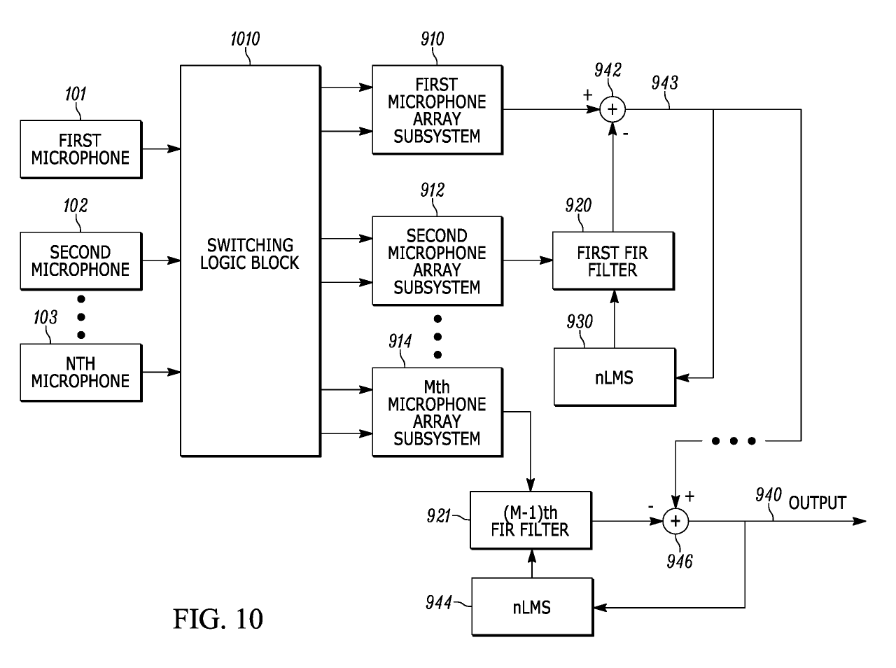

Multiple alternative embodiments of FIG. 9 are possible. FIG. 10 is a hardware block diagram of a third illustrative adaptive microphone array for providing multiple-side interference cancellation in accordance with a set of exemplary embodiments. It may be recognized that common blocks and elements can be used to construct the configuration of FIG. 10 relative to the blocks and elements shown in FIG. 9. To facilitate understanding, identical reference numerals have been used in FIGS. 9 and 10, wherever possible, to designate identical elements that are common to these figures. The alternative system of FIG. 10 particularly utilizes a switching logic block 1010, in which an appropriate directional microphone of the first, second, and Nth microphones 101, 102, and 103, or pair of these microphones, or group of these microphones, is operatively coupled to any of the first, second, and Mth microphone array subsystems 910, 912, and 914. Each of the microphone array subsystems 910, 912, 914 forms a respective spatial directional pattern by internally performing signal combining by using, for example, mixed differential processing, or delay and sum processing.

Additionally, notwithstanding any of the above discussion concerning FIGS. 9 and 10 regarding the presence of N microphones and M microphone array subsystems (as well as related numbers of associated components), it should be appreciated that the present disclosure also encompasses any of a variety of embodiments having any of a variety of numbers of microphones and microphone array subsystems and other components other than as specifically described above. Among other things, for example, it should be appreciated that the numbers N and M corresponding respectively to the numbers of microphones and microphone array subsystems can, depending upon the embodiment, be different (e.g., N greater than or less than M) or be the same (N=M), and that it is intended that the present disclosure encompass all such embodiments.

It is specifically intended that the present disclosure not be limited to the particular embodiments and illustrations contained herein. For example, even though FIG. 6 illustrates directions of desired sources, as well as sources of interference, in an implied two-dimensional frame of reference, the embodiments disclosed herein have no such restrictions. In other words, a system utilizing any of the methods or devices described herein can be constructed to cancel interference in both azimuth as well as elevation from the desired source, dependent on the geometry of the physical microphone array.

Many adaptive array systems tend to rely on additional supporting mechanisms which may be essential or desirable for purposes of providing optimal operation of the array, but not all of these supporting mechanisms are explicitly illustrated in the drawings. One such mechanism is voice activity detection (VAD). VAD is often useful in the context of adaptive arrays in order to detect a presence of desired talker activity and, in response thereto, to slow down the adaptation process, or even freeze adaptation. This slowing down is performed in order to minimize audible artifacts introduced in the desired talker's speech by the FIR filter(s) continuously changing weights.

Another supporting mechanism is control of adaptation rate for the multiple nLMS loops present in these embodiments. The adaptation times for each of the successive loops is subject to optimization for specific geometrical and system requirements. Other details include the size of the FIR filters if an FIR mechanism is used. By way of illustration, an adaptive system may be set up such that a fast convergence rate is achieved in the loop using a dipole reference, with slower convergence rates being provided in successive loops. The successive loops may require longer FIR filters in order to perform better tracking and extraction of the remaining interference signals. These and other constraints are not essential for the idea presented.

Although some of the embodiments disclosed herein describe use of FIR filters in an adaptive system, this is for illustrative purposes only. Adaptation using recursive filters, as well as adaptation in the frequency domain, can also be used. Forming one or more constituent elements for microphone arrays can also be performed using various combinations of time delay (including fractional), time domain FIR or infinite impulse response (IIR) filtering, as well as frequency domain filtering and processing. The choice of one approach versus the other is based on factors such as: available code base, other processing already done in the system, computational costs, current drain costs, development costs and time schedules.

It should be appreciated that one or more embodiment encompassed by the present disclosure are advantageous in one or more respects. Thus, it is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A method comprising:
configuring a plurality of microphones in an array to gather signals from a desired source of sound in a main lobe of the array;
configuring the plurality of microphones to gather side interference by controlling at least one of a relative phase or a relative magnitude of signals gathered by each of the plurality of microphones to provide a respective plurality of microphone arrays each having a corresponding directional pattern that orients a null towards the desired source of sound and that provides one or more side lobes; and
processing the gathered side interference from the plurality of microphone arrays to generate a reference signal that is subtracted from the signals that are gathered from the main lobe of the array to provide an output signal wherein the side interference is reduced or cancelled.

2. The method of claim 1 wherein the one or more side lobes comprise a first side lobe oriented for gathering side interference from a right side of the array and a second side lobe oriented for gathering side interference from a left side of the array.

3. The method of claim 2 wherein a first source of side interference is situated in the first side lobe and a second source of side interference is situated in the second side lobe, and the output signal reduces or cancels interference from both the first source of interference and the second source of interference, and wherein the first side lobe is either situated in a plane that includes the plurality of microphone arrays, or the first side lobe is situated above the plurality of microphone arrays.

4. The method of claim 1 wherein at least one corresponding directional pattern is substantially cardioid-shaped.

5. The method of claim 1 further comprising providing a plurality of limacon-shaped directional patterns, each of the respective plurality of limacon-shaped patterns being oriented to provide a corresponding null that point to where a desired signal source is expected to be situated, and each of the plurality of limacon-shaped patterns serving as reference for one or multiple side interference sources to be removed.

6. The method of claim 1 further comprising applying the reference signal to a noise suppressor.

7. The method of claim 1 further comprising generating the reference signal using at least one adaptive mechanism for removing interference.

8. An apparatus comprising:
a plurality of microphones arranged in an array for gathering signals from a desired source of sound in a main lobe of the array;
a phasing or filtering mechanism, operatively coupled to the plurality of microphones, for gathering side interference by controlling at least one of a relative phase or a relative magnitude of signals gathered by each of the plurality of microphones to provide a respective plurality of microphone arrays each having a corresponding directional pattern that orients a null towards the desired source of sound and that provides one or more side lobes; and
a processing mechanism, operatively coupled to the phasing or filtering mechanism and the array, for processing the gathered side interference from the plurality of differential microphone arrays to generate a reference signal that is subtracted from the signals that are gathered from the main lobe of the array to provide an output signal wherein the side interference is reduced or cancelled.

9. The apparatus of claim 8 wherein the one or more side lobes comprise a first side lobe oriented for gathering side interference from a right side of the array or above the array, and a second side lobe oriented for gathering side interference from a left side of the array or below the array.

10. The apparatus of claim 9 wherein a first source of side interference is situated in the first side lobe and a second source of side interference is situated in the second side lobe, and the output signal reduces or cancels interference from both the first source of interference and the second source of interference.

11. The apparatus of claim 8 wherein at least one corresponding directional pattern is substantially cardioid-shaped.

12. The apparatus of claim 8 configured to provide a plurality of limacon-shaped directional patterns, each of the respective plurality of limacon-shaped patterns being oriented to provide a corresponding null that point to where a desired signal source is expected to be situated, and each of the plurality of limacon-shaped patterns serving as reference for one or multiple side interference sources to be removed.

13. The apparatus of claim 8 wherein the processing mechanism further comprises a noise suppressor for processing the reference signal.

14. The apparatus of claim 8 wherein the processing mechanism is configured for using at least one adaptive mechanism to remove interference.

15. A non-transitory computer-readable memory encoded with a computer program comprising computer readable instructions recorded thereon for execution of a method that includes:
configuring a plurality of microphones in an array to gather signals from a desired source of sound in a main lobe of the array;
configuring the plurality of microphones to gather side interference by controlling a relative phase and/or magnitude of signals gathered by each of the plurality of microphones to provide a respective plurality of microphone arrays each having a corresponding directional pattern that orients a null towards the desired source of sound and that provides one or more side lobes; and
processing the gathered side interference from the plurality of differential microphone arrays to generate a reference signal that is subtracted from the signals that are gathered from the main lobe of the array to provide an output signal wherein the side interference is reduced or cancelled.

16. The non-transitory computer-readable memory of claim 15 further comprising instructions for providing the one or more side lobes as a first side lobe oriented for gathering side interference from a right side of the array or above the array, and a second side lobe oriented for gathering side interference from a left side of the array or below the array.

17. The non-transitory computer-readable memory of claim 16 wherein a first source of side interference is situated in the first side lobe and a second source of side interference is situated in the second side lobe, and the output signal reduces or cancels interference from both the first source of interference and the second source of interference.

18. The non-transitory computer-readable memory of claim 15 further comprising instructions for providing at least one corresponding directional pattern as a substantially cardioid-shaped pattern.

19. The non-transitory computer-readable memory of claim 15 further comprising instructions for providing a plurality of limacon-shaped directional patterns, each of the respective plurality of limacon-shaped patterns being oriented to provide a corresponding null that point to where a desired signal source is expected to be situated, and each of the plurality of limacon-shaped patterns serving as reference for one or multiple side interference sources to be removed.

20. The non-transitory computer-readable memory of claim 15 further comprising instructions for applying the reference signal to a noise suppressor.

21. The non-transitory computer-readable memory of claim 15 further comprising instructions for using at least one adaptive mechanism for removing interference.
